(19) United States
(12) Patent Application Publication
(10) Pub. No.: US 2026/0367767 A1
(43) Pub. Date: Nov. 19, 2026

(54) INFORMATION INTERACTION METHOD, DEVICE AND READABLE STORAGE MEDIUM

(71) Applicant: Beijing Zitiao Network Technology Co., Ltd., Beijing (CN)

(72) Inventors: Bin LI, Beijing (CN); Wencheng ZHANG, Beijing (CN); Wenjie FU, Beijing (CN); Lingmin LIN, Beijing (CN); Yunhan HAO, Beijing (CN); Shuping WANG, Beijing (CN); Meng LI, Beijing (CN); Jindong HONG, Hong Kong (HK); Yijun HE, Beijing (CN); Chu LIU, Beijing (CN); Lin OU, Beijing (CN)

(21) Appl. No.: 19/682,140

(22) Filed: May 19, 2026

(30) Foreign Application Priority Data
May 19, 2025 (CN) 202510646947.8

(51) Int. Cl. G06F 3/0484; G06F 40/40; H04L 51/02

(52) U.S. Cl. CPC G06F 3/0484; G06F 40/40; H04L 51/02

(57) ABSTRACT

Embodiments of the present disclosure provide an information interaction method, a device, and a readable storage medium. The method includes: receiving a chat message sent by a peer end; in response to determining to provide an interaction option based on the chat message, providing the interaction option according to message content of the chat message, where the interaction option is associated with recommended reply content; and receiving an operation of a user on the interaction option, and displaying the recommended reply content associated with the interaction option.

### CROSS-REFERENCE TO RELATED APPLICATION

This application claims the priority to and benefits of the Chinese Patent Application, No.202510646947.8, which was filed on May 19, 2025. All the aforementioned patent applications are hereby incorporated by reference in their entireties.

### TECHNICAL FIELD

Embodiments of the present disclosure relate to an information interaction method and device, a readable storage medium and a program product.

### BACKGROUND

With the development of technologies, a user may have a chat with an intelligent assistant running in a terminal device. In some application scenarios, when interacting with the intelligent assistant, the user needs to repeatedly input similar information or repeatedly make simple replies. Such an interaction manner leads to low interaction efficiency. In addition, multiple rounds of such interactions may bring a poor experience for the user.

### SUMMARY

Embodiments of the present disclosure provide an information interaction method and device, a readable storage medium and a program product.

At least one embodiment of the present disclosure provides an information interaction method, including:
receiving a chat message sent by a peer end;
in response to determining to provide an interaction option based on the chat message, providing the interaction option according to message content of the chat message, wherein the interaction option is associated with recommended reply content; and
receiving an operation of a user on the interaction option, and displaying the recommended reply content associated with the interaction option.

At least one embodiment of the present disclosure provides an information interaction device, including:
a receiving unit, configured to receive a chat message sent by a peer end;
a generation unit, configured to, in response to determining to provide an interaction option based on the chat message, provide the interaction option according to message content of the chat message, where the interaction option is associated with recommended reply content; and
a displaying unit, configured to receive an operation of a user on the interaction option, and display the recommended reply content associated with the interaction option.

At least one embodiment of the present disclosure provides an electronic device, including: a processor and a memory;
where the memory stores computer-executed instructions; and
the processor executes the computer-executed instructions stored in the memory, to cause the at least one processor to execute the information interaction method according to the first aspect and various possible designs of the first aspect above.

At least one embodiment of the present disclosure provides a computer-readable storage medium, where computer-executed instructions are stored in the computer-readable storage medium, and when the computer-executed instructions are executed by a processor, the information interaction method according to the first aspect and various possible designs of the first aspect above is implemented.

At least one embodiment of the present disclosure provides a computer program product, including a computer program, where when the computer program is executed by a processor, the information interaction method according to the first aspect and various possible designs of the first aspect above is implemented.

### BRIEF DESCRIPTION OF DRAWINGS

In order to more clearly describe the technical solutions in the embodiments of the present disclosure, the following briefly introduces the drawings that need to be used in the description of the embodiments. Obviously, the drawings in the following description are some embodiments of the present disclosure, and for those of ordinary skill in the art, other drawings may also be obtained from these drawings without creative work.

FIG. 1 is a first schematic flowchart of an information interaction method provided by an embodiment of the present disclosure;

FIG. 2 is a schematic diagram of an application scenario;

FIG. 3 is a second schematic flowchart of an information interaction method provided by an embodiment of the present disclosure;

FIG. 4 is a third schematic flowchart of an information interaction method provided by an embodiment of the present disclosure;

FIG. 5 is a principle flowchart of an information interaction method provided by the present disclosure;

FIG. 6 is a structural block diagram of an information interaction device provided by an embodiment of the present disclosure; and

FIG. 7 is a schematic hardware structural diagram of an electronic device provided by an embodiment of the present disclosure.

### DETAILED DESCRIPTION

In order to make objectives, technical solutions and advantages of embodiments of the present disclosure clearer, the technical solutions in the embodiments of the present disclosure will be described clearly and comprehensively with reference to the drawings in the embodiments of the present disclosure. Obviously, the described embodiments are part of the embodiments of the present disclosure, rather than all of them. All other embodiments obtained by those of ordinary skill in the art without paying any creative effort based on the embodiments in the present disclosure belong to the protection scope of the present disclosure.

Different chat participants may send messages to each other in a chat for information interaction. In the chat process, each chat participant needs to input a large amount of message content in the form of voice or text input, resulting in low information interaction efficiency. In particular, when the chat participants include a user and a virtual object (such as an intelligent assistant), the user needs to repeatedly input the same message when consulting the virtual object for information in multiple rounds. Such multiple rounds of information interaction will bring a poor experience for the user, and the information interaction efficiency is still relatively low.

According to the solution provided in the present disclosure, after a chat message sent by a peer end is received, if it is determined to provide an interaction option based on the chat message, the interaction option is provided according to message content of the chat message, and recommended reply content is associated with the interaction option, so that the user may perform a trigger operation on the displayed interaction option to automatically input reply content to reply to the peer end. In this manner, the user is assisted in replying to the chat message, which helps improve information interaction efficiency and may improve user experience.

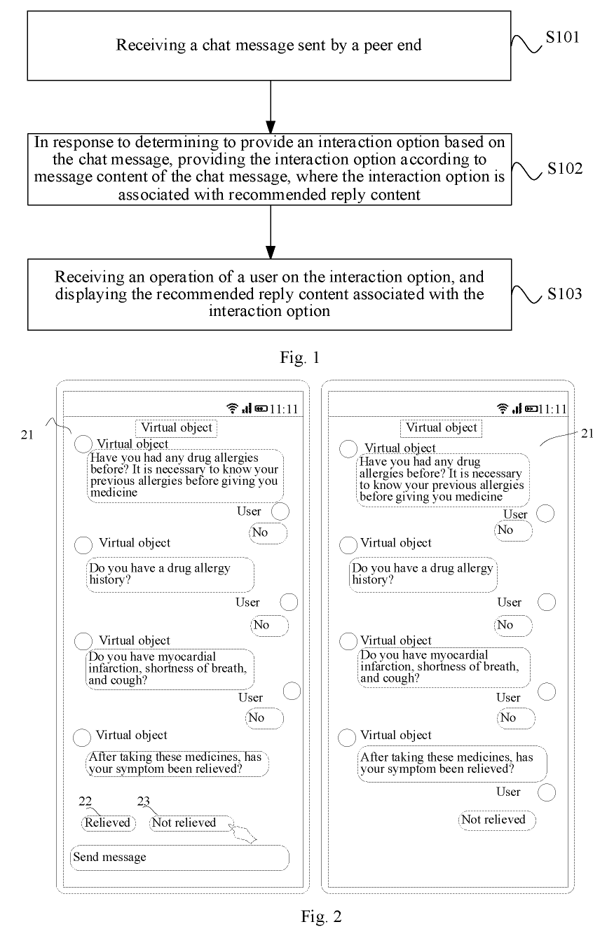

Please refer to FIG. 1. FIG. 1 shows a first schematic flowchart of an information interaction method provided by the present disclosure. As shown in FIG. 1, the method includes the following steps.

S101: receiving a chat message sent by a peer end.

In the embodiment, an execution body of the information interaction method may be a terminal device, and specifically may be an application client running in the terminal device. The application may be various types of applications that support chats, such as social applications, e-commerce applications, and consultation applications.

The application may support the user to have a chat with the peer end. The peer end may be another user or a virtual object. When having a chat with the user, the virtual object sends a chat message output by a language processing model to the user.

In an example, the peer end may be another user. In this example, the user may log in to the application and have a chat with the another user through the application. The chat message sent by the peer end may be an original message or a reply message for an original message sent by the user.

In an example, the peer end may be a virtual object. In this example, after logging in to the application, the user may initiate a chat with the virtual object, for example, initiate information consultation with the virtual object, and the virtual object replies according to a consultation message from the user. In this example, the chat message may be any chat message output by the virtual object.

S102: in response to determining to provide an interaction option based on the chat message, providing the interaction option according to message content of the chat message, where the interaction option is associated with recommended reply content.

After receiving the chat message, the execution body may determine whether to provide the interaction option based on the message content of the chat message. When it is determined to provide the interaction option based on the message content of the chat message, the interaction option is provided according to the message content of the chat message in various manners. The number of provided interaction options may be one or more. Each interaction option is associated with one piece of recommended reply content.

In an example, a message type of the chat message may be determined according to semantics of the chat message or an expression manner of the chat message, and whether to provide the interaction option according to the message content of the chat message is determined according to the message type. When the message type of the chat message is a target message type, it is determined that the interaction option may be provided according to the message content of the chat message. The target message type includes but is not limited to: a yes/no type message, a selection type message, and the like.

As an example, a keyword may be extracted from the chat message, reply content may be generated according to the keyword, and then an interaction option including the reply content may be generated. For example, when the chat message is "Do you feel headache?", keyword extraction may be performed on the chat message to obtain the keyword "headache", recommended reply content "headache" may be generated, and an interaction option associated with the recommended reply content may be generated.

The execution body may display the interaction option in a chat interface. In some examples, the interaction option may be displayed near a message input box, for example, above the message input box, so that the user may perform an operation on the interaction option.

S103: receiving an operation of a user on the interaction option, and displaying the recommended reply content associated with the interaction option.

In some implementations, the method further includes the following steps:
sending the recommended reply content to the peer end; and
displaying the recommended reply content in a message stream in the chat interface while sending the recommended reply content to the peer end.

In an implementation, the user may perform a trigger operation on the interaction option, and the recommended reply content associated with the interaction option may be sent to the peer end.

In an implementation, the trigger operation performed by the user on the interaction option is received, and the recommended reply content associated with the interaction option is input into the message input box. The user may edit the recommended reply content in the message input box, and send an edited reply message to the peer end. The user may also directly send the recommended reply content input into the message input box to the peer end, for example, perform a trigger operation on a sending control corresponding to the message input box, so that the recommended reply content is sent to the peer end.

Please refer to FIG. 2. FIG. 2 is a schematic diagram of an application scenario. In the scenario shown in FIG. 2, a user initiates a chat with a virtual object in a social application, and performs medical consultation in a chat interface 21. In the chat interface 21, the user may have multiple rounds of chats with the virtual object. Part of chat messages between the user and the virtual object are displayed in the chat interface 21: a message "Do you have a drug allergy history?" sent by the virtual object, and a reply message "No" to the message from the user; a message "Do you have palpitation, shortness of breath and cough?" sent by the virtual object, and a reply message "No" to the message from the user; and a latest message "After taking these medicines, has your symptom been relieved?" sent by the virtual object.

The execution body may analyze whether an interaction option may be generated according to message content of the latest message. When it is determined that the interaction option may be generated according to the message content of the latest message, recommended reply content 1 "Relieved" and recommended reply content 2 "Not relieved" may be generated according to the message content of the latest message. Then an interaction option 22 is generated according to the recommended reply content 1, and an interaction option 23 is generated according to the recommended reply content 2. The user may perform a trigger operation on the interaction option 23. After receiving the trigger operation performed by the user on the interaction option 23, the execution body may send recommended reply content "Not relieved" associated with the interaction option to the virtual object, and display the recommended reply content 2 in the chat interface 21.

In the embodiment, after the chat message sent by the peer end is received, when it is determined to provide the interaction option based on the chat message, the interaction option is provided according to the message content of the chat message, where the interaction option is associated with the recommended reply content; and the operation of the user on the interaction option is received, and the recommended reply content associated with the interaction option is displayed. In this manner, the user is assisted in replying to the chat message, which helps improve information interaction efficiency and may improve user experience.

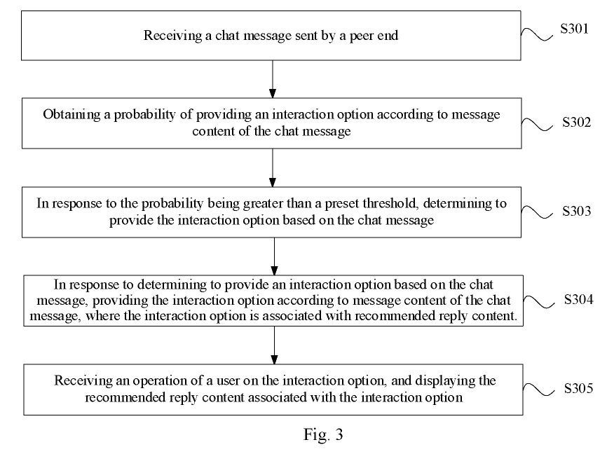

Please refer to FIG. 3. FIG. 3 is a second schematic diagram of an information interaction method provided by the present disclosure. As shown in FIG. 3, the method includes the following steps.

S301: receiving a chat message sent by a peer end.

In the embodiment, an execution body of the information interaction method may be a terminal device. For the specific implementation of step S301, reference may be made to the description of step S101 in the embodiment shown in FIG. 1, which will not be repeated here.

S302: obtaining a probability of providing an interaction option according to message content of the chat message.

In an example, when it is determined, according to semantics of the chat message or an expression form of the chat message, that the chat message is a chat message of a target type, a corresponding probability may be a first preset probability value (for example, 1); when the chat message does not belong to the chat message of the target type, the probability corresponding to the chat message may be a second preset probability value (for example, 0).

In some implementations, step S302 includes:
inputting the chat message to a probability prediction model, and outputting, by the probability prediction model, the probability of providing the interaction option according to the message content of the chat message.

The probability prediction model may output, according to the input chat message, the probability of providing the interaction option according to the chat message.

The probability prediction model may be various classification models, such as a binary classification model. The probability prediction model may classify the chat message. The output of the probability prediction model may include two categories: being capable of providing the interaction option and being incapable of providing the interaction option.

In these implementations, the probability prediction model is used to determine whether the interaction option may be provided according to the chat message. This may improve the efficiency of determining whether the interaction option may be provided.

S303: in response to the probability being greater than a preset threshold, determining to provide the interaction option based on the chat message.

The preset threshold may be set according to a specific application scenario, which is not limited here. As an example, the preset threshold may be 0.5.

In a case that the probability is greater than or equal to the preset threshold, it is determined that the recommended reply content is provided according to the chat message. In a case that the probability is less than the preset threshold, it is determined that the recommended reply content is not provided according to the chat message.

S304: in response to determining to provide an interaction option based on the chat message, providing the interaction option according to message content of the chat message, where the interaction option is associated with recommended reply content.

In some implementations, step S304 includes the following steps.

First, in response to determining to provide the interaction option based on the chat message, inputting the chat message into a content generation model, and generating, by the content generation model, the recommended reply content according to the message content of the chat message.

After it is determined in step S303 to provide the interaction option according to the chat message, the chat message may be input into the content generation model. The content generation model may be any language processing model, which has the ability to summarize, rewrite and expand content.

In an example, the chat message may be written into first prompt information, and the first prompt information may include processing logic for generating the recommended reply content according to the chat message, and may also include an output format of the recommended reply content.

The content generation model may process the chat message according to the processing logic in the first prompt information to obtain the recommended reply content, and output the recommended reply content according to the output format of the first prompt information.

Then, the recommended reply content output by the content generation model is received, and the interaction option including the recommended reply content is generated.

The execution body may receive one or more pieces of recommended reply content output by the content generation model, and then generate interaction options respectively corresponding to the pieces of recommended reply content.

In an example, the interaction option may be displayed near a message input box.

In an example, the interaction option may be displayed near the chat message.

S305: receiving an operation of a user on the interaction option, and displaying the recommended reply content associated with the interaction option.

In the embodiment, a probability of generating an interaction option according to a chat message is obtained, and when it is determined, based on the probability, that the interaction option may be provided according to the chat message, the chat message is input into a content generation model, and the chat message is processed by the content generation model to generate recommended reply content; and then the interaction option is generated according to the recommended reply content. In this manner, the efficiency of parsing the chat message and providing the interaction option according to the chat message is improved, which helps improve information interaction efficiency.

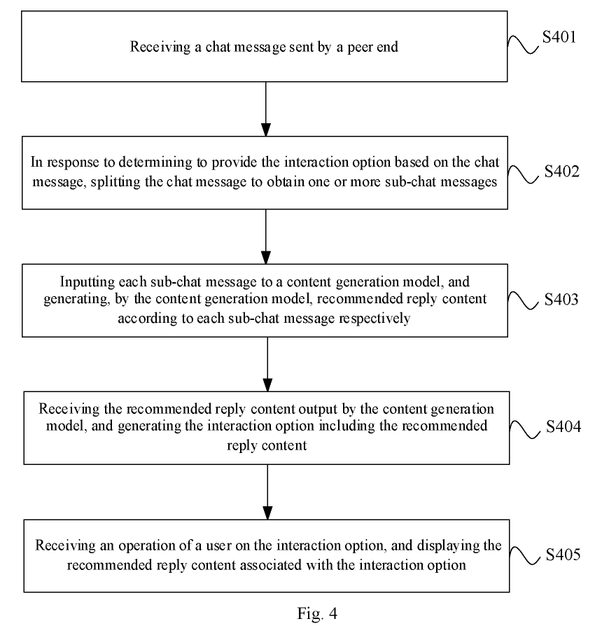

Please refer to FIG. 4. FIG. 4 is a third schematic flowchart of an information interaction method provided by the present disclosure. As shown in FIG. 4, the method includes the following steps.

S401: receiving a chat message sent by a peer end.

For the specific implementation of step S401, reference may be made to the relevant description of the embodiment shown in FIG. 1, which will not be repeated here.

S402: in response to determining to provide the interaction option based on the chat message, splitting the chat message to obtain one or more sub-chat messages.

In the embodiment, an execution body of the information interaction method may be a terminal device, and specifically may be an application running in the terminal device. The execution body may determine, using various methods, whether to provide the interaction option based on the chat message. For example, when it is determined to provide the interaction option based on the chat message, an operation of splitting the chat message may be performed to split the chat message into one or more sub-chat messages. Each sub-chat message has a complete meaning, and different sub-chat messages are not related to each other and need to be replied to separately.

For example, when the chat message is "How is your sleep quality? Do you feel more tired?", the chat message may be split to obtain the following sub-chat messages: "How is your sleep quality" and "Do you feel more tired?".

In some implementations, step S402 includes the following steps.

First, prompt information including the chat message and splitting logic is generated, where the splitting logic is used to split the chat message into one or more sub-chat messages.

Then, the prompt information is input into a language processing model, and the chat message is split, by the language processing model, into one or more sub-chat messages according to the splitting logic.

The prompt information may include logic for splitting the chat message. In an example, the splitting logic includes splitting the chat message according to semantics. For example, when the chat message includes a plurality of questions, the chat message may be split into one or more sub-chat messages according to the semantics, and each of the split sub-chat messages needs to be replied to separately.

In an example, the prompt information includes the following prompt content: when the chat message is a separate question, a sub-chat message of the chat message is the chat message per se; and when the chat message includes the plurality of questions, the chat message is split according to the questions to obtain the plurality of sub-chat messages, and each sub-chat message is a question that needs to be replied to separately. The prompt information may further include an output format of one or more sub-chat messages.

The execution body may receive the one or more sub-chat messages that are obtained by splitting the chat message and output by the language processing model.

By generating the prompt information and instructing the language processing model to split the chat message according to the prompt information, a more accurate splitting result may be obtained, which helps improve the accuracy of the generated recommended reply content.

S403: inputting each sub-chat message to a content generation model, and generating, by the content generation model, recommended reply content according to each sub-chat message respectively.

After one or more sub-chat messages are obtained, the sub-chat messages may be sent to the content generation model. In an example, the plurality of sub-chat messages may be sequentially written into prompt information to be sent to the content generation model, and the prompt information may include instruction information instructing the content generation model to generate recommended reply content for the sub-chat messages. The content generation model generates respective recommended reply content for each of the sub-chat messages according to the prompt information.

In addition, the prompt information also indicates an output format of each piece of recommended reply content. In an example, the prompt information indicates that for each sub-chat message, output of recommended reply content of the sub-chat message may be set to be output after the sub-chat message. In the output of the content generation model, the recommended reply content of each sub-chat message is output immediately after the recommended reply content. This helps the execution body distinguish each sub-chat message and the corresponding recommended reply content, and generate an interaction option for each sub-chat message according to the recommended reply content of the sub-chat message.

In an example, the sub-chat messages may be sequentially sent to the content generation model, and the content generation model sequentially generates recommended reply content for each of the sub-chat messages.

S404: receiving the recommended reply content output by the content generation model, and generating the interaction option including the recommended reply content.

S405: receiving an operation of a user on the interaction option, and displaying the recommended reply content associated with the interaction option.

For each sub-chat message, an interaction option corresponding to each piece of recommended reply content of the sub-chat message may be generated. Interaction options respectively corresponding to the sub-chat messages may be displayed.

In the embodiment, when it is determined that the recommended reply content may be generated according to the chat message, the chat message is split, and the recommended reply content is generated for each of the split sub-chat messages. In this manner, accurate reply content may be generated for each of the sub-chat messages, which helps improve information interaction efficiency.

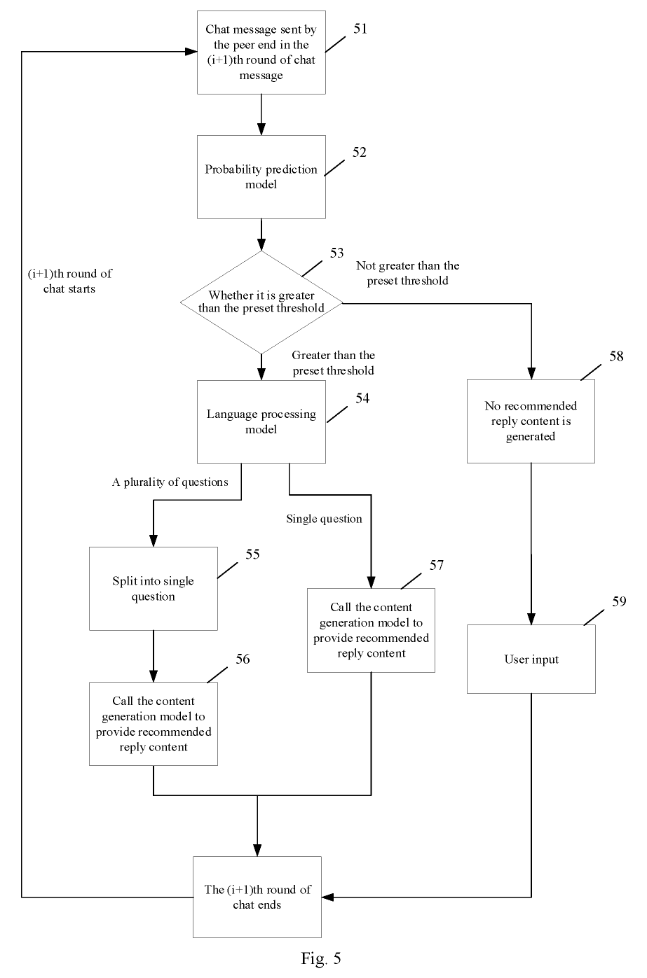

Please refer to FIG. 5. FIG. 5 is a schematic diagram of an application scenario of an information interaction method provided by the present disclosure. As shown in FIG. 5, in a process where a user uses an application client to have a chat with a peer end, a chat message 51 sent by the peer end in an ith round of chat message is received. The application client may input the chat message into a probability prediction model 52, and the probability prediction model outputs a probability of providing an interaction option according to message content of the chat message. The application client may determine whether the probability is greater than or equal to a preset threshold 53. When it is determined that the probability is less than the preset threshold, it is determined not to generate recommended reply content 58, and no recommended reply content is displayed. Reply content 59 input by the user may be received. The ith round of chat ends.

When it is determined that the probability output by the probability prediction model is greater than or equal to the preset threshold, it is determined that the interaction option may be provided according to the chat message. The chat message may be input into a language model 54, and the chat message is split by the language processing model. Specifically, the language processing model determines whether the chat message includes a single question or a plurality of questions. When the chat message includes the plurality of questions, the language processing model splits the plurality of questions in the chat message into the plurality of single questions (that is, the plurality of sub-chat messages) 55. The language processing model is called to generate recommended reply content 56 respectively corresponding to the multiple single questions. When the chat message includes a single question, a splitting result of the chat message is the chat message, and the content generation model is called to generate recommended reply content of the single question. The interaction option associated with the recommended reply content is generated. The interaction option is displayed. The operation of the user on the interaction option is received, and the recommended reply content is displayed. The user may select and trigger a target interaction option from the interaction options to reply, and the ith round of chat ends. In addition, when the interaction option associated with the recommended reply content is displayed in the chat interface, the user may also input reply content in the message input box without performing an operation on the interaction option, the ith round of chat ends, and an (i+1)th round of chat starts.

In the application scenario, the recommended reply content for each question may be generated quickly and accurately, and information interaction efficiency may be improved.

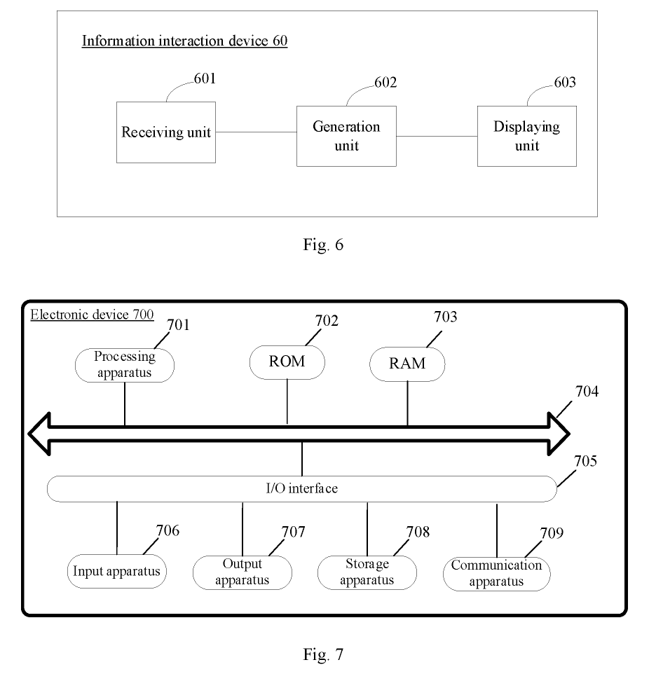

Corresponding to the information interaction method in the above embodiments, FIG. 6 is a structural block diagram of an information interaction device provided by an embodiment of the present disclosure. For ease of description, only parts related to the embodiments of the present disclosure are shown. Referring to FIG. 6, the device 60 includes: a receiving unit 601, a generation unit 602 and a displaying unit 603, where,
the receiving unit 601 is configured to receive a chat message sent by a peer end;
the generation unit 602 is configured to in response to determining to provide an interaction option based on the chat message, provide the interaction option according to message content of the chat message, wherein the interaction option is associated with recommended reply content; and
the displaying unit 603 is configured to receive an operation of a user on the interaction option, and display the recommended reply content associated with the interaction option.

In the information interaction device provided in the embodiment, after the chat message sent by the peer end is received by the receiving unit, the generation unit provide the interaction option according to message content of the chat message in response to determining to provide an interaction option based on the chat message, where the interaction option is associated with the recommended reply content; and the displaying unit receives the operation of the user on the interaction option, and displays the recommended reply content associated with the interaction option. In this manner, the user is assisted in replying to the chat message, which helps improve information interaction efficiency and may improve user experience.

In an embodiment of the present disclosure, the device 60 further includes a determining unit (not shown in the figure), where the determining unit is configured to:
obtain a probability of providing the interaction option according to the message content of the chat message; and
in response to the probability being greater than a preset threshold, determining to provide the interaction option based on the chat message.

In summary, furthermore, the probability of generating the interaction option according to the chat message is obtained by the determining unit, and when it is determined, based on the probability, that the interaction option may be generated according to the chat message, the chat message is input into the content generation model, and the chat message is processed by the content generation model to generate the recommended reply content; and then the interaction option is provided according to the recommended reply content. In this manner, the efficiency of parsing the chat message and generating the interaction option according to the chat message is improved, which helps improve information interaction efficiency.

In an embodiment of the present disclosure, the determining unit is further configured to:
input the chat message to a probability prediction model, and output, by the probability prediction model, the probability of providing the interaction option according to the message content of the chat message.

In summary, furthermore, the probability prediction model is used to determine whether the interaction option may be provided according to the chat message. This may improve the efficiency of determining whether the interaction option may be provided.

In an embodiment of the present disclosure, the generation unit 602 is further configured to:
in response to determining to provide the interaction option based on the chat message input the chat message into a content generation model, and generate, by the content generation model, the recommended reply content according to the message content of the chat message; and
receive the recommended reply content output by the content generation model, and generate the interaction option including the recommended reply content.

In summary, furthermore, the chat message is processed by the content generation model to generate the recommended reply content, and the interaction option is generated according to the recommended reply content. In this manner, the efficiency of parsing the chat message and providing the interaction option according to the chat message is improved, which helps improve information interaction efficiency.

In an embodiment of the present disclosure, the device 60 further includes a splitting unit (not shown in the figure), where the splitting unit is configured to:
split the chat message to obtain one or more sub-chat messages; and
the generation unit 602 is further configured to:
input each sub-chat message to the content generation model, and generate, by the content generation model, the recommended reply content according to each sub-chat message respectively.

In summary, furthermore, when it is determined that the recommended reply content may be generated according to the chat message, the chat message is split, and the recommended reply content is generated for each of the split sub-chat messages. In this manner, accurate reply content may be generated for each of the sub-chat messages, which helps improve information interaction efficiency.

In an embodiment of the present disclosure, the splitting unit is further configured to:
generate prompt information including the chat message and splitting logic, where the splitting logic is used to split the chat message into the one or more sub-chat messages; and
input the prompt information into a language processing model, and split, by the language processing model, the chat message into one or more sub-chat messages according to the splitting logic.

In summary, furthermore, by generating the prompt information and instructing the language processing model to split the chat message according to the prompt information, a more accurate splitting result may be obtained, which helps improve the accuracy of the generated recommended reply content.

In an embodiment of the present disclosure, the device 60 further includes a sending unit (not shown in the figure), where the sending unit is configured to:
send the recommended reply content to the peer end.

The device provided in the embodiment may be used to implement the technical solutions of the above method embodiments, and the implementation principles and technical effects thereof are similar, and details are not described herein again in the embodiment.

In order to implement the above embodiments, an embodiment of the present disclosure further provides an electronic device.

Referring to FIG. 7, FIG. 7 shows a schematic structural diagram of an electronic device 700 suitable for implementing the embodiments of the present disclosure, and the electronic device 700 may be a terminal device or a server. The terminal device may include, but is not limited to, a mobile terminal such as a mobile phone, a notebook computer, a digital broadcast receiver, a personal digital assistant (abbreviated as PDA), a tablet computer, a portable media player (abbreviated as PMP), an in-vehicle terminal (such as an in-vehicle navigation terminal), etc., and a fixed terminal such as a digital TV, a desktop computer, etc. The electronic device shown in FIG. 7 is only an example, which should not impose any limitation on the functions and the range of use of the embodiments of the present disclosure.

As shown in FIG. 7, the electronic device 700 may include a processing apparatus (such as a central processing unit, a graphics processor and the like) 701, which may perform various appropriate actions and processing according to a program stored in a read-only memory (abbreviated as ROM) 702 or a program loaded from a storage apparatus 708 into a random access memory (abbreviated as RAM) 703. In the RAM 703, various programs and data required for operations of the electronic device 700 are also stored. The processing apparatus 701, the ROM 702 and the RAM 703 are connected to each other through a bus 704. An input/output (I/O) interface 705 is also connected to the bus 704.

Usually, the following apparatuses may be connected to the I/O interface 705: an input apparatus 706 including, for example, a touch screen, a touchpad, a keyboard, a mouse, a camera, a microphone, an accelerometer, a gyroscope and the like; an output apparatus 707 including, for example, a liquid crystal display (Liquid Crystal Display, LCD for short), a speaker, a vibrator and the like; a storage apparatus 708 including, for example, a magnetic tape, a hard disk and the like; and a communication apparatus 709. The communication apparatus 709 may allow the electronic device 700 to perform wireless or wired communication with other devices to exchange data. Although FIG. 7 shows the electronic device 700 having various apparatuses, it should be understood that it is not required to implement or have all the shown apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a computer-readable medium, where the computer program includes program code for performing the method shown in the flowchart. In such an embodiment, the computer program may be downloaded and installed from a network through the communication apparatus 709, or installed from the storage apparatus 708, or installed from the ROM 702. When the computer program is executed by the processing apparatus 701, the above-mentioned functions defined in the method of the embodiments of the present disclosure are executed.

It should be noted that the above computer-readable medium in the present disclosure may be a computer-readable signal medium, a computer-readable storage medium, or any combination of the two. The computer-readable storage medium may be, for example, but is not limited to, an electronic, magnetic, optical, electromagnetic, infrared, or semiconductor system, apparatus or device, or any combination of the above. More specific examples of the computer-readable storage medium may include, but are not limited to: an electrically connected portable computer magnetic disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated on a baseband or as a part of a carrier, and computer-readable program code is carried in the data signal. This propagated data signal may adopt multiple forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program used by or in combination with an instruction execution system, apparatus or device. The program code contained on the computer-readable medium may be transmitted in any suitable medium, including but not limited to: a wire, an optical cable, a radio frequency (RF), etc., or any suitable combination of the above.

The above computer-readable medium may be contained in the above electronic device, or may exist alone without being assembled into the electronic device.

The above computer-readable medium carries one or more programs, and when the one or more programs are executed by the electronic device, the electronic device is caused to execute the method shown in the above embodiments.

Computer program code for executing the operations of the present disclosure may be written in one or more programming languages or a combination thereof, where the programming languages include object-oriented programming languages such as Java, Smalltalk, C++, and conventional procedural programming languages such as "C" language or similar programming languages. The program code may be completely executed on a user computer, partially executed on a user computer, executed as an independent software package, partially executed on a user computer and partially executed on a remote computer, or completely executed on a remote computer or server. In the case of involving a remote computer, the remote computer may be connected to the user computer through any kind of network, including a local area network (Local Area Network, LAN for short) or a wide area network (Wide Area Network, WAN for short), or it may be connected to an external computer (for example, connected by using Internet provided by an Internet service provider).

The flowcharts and block diagrams in the drawings illustrate the possibly implemented architectures, functions and operations of the system, the method and the computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or by a combination of dedicated hardware and computer instructions.

The involved units described in the embodiments of the present disclosure may be implemented by software or by hardware. Among them, the name of a unit does not constitute a limitation on the unit itself under certain circumstances, for example, the first acquisition unit may also be described as "a unit for acquiring at least two internet protocol addresses".

The functions described above may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

According to the electronic device, the computer-readable storage medium and the computer program product provided by the embodiments of the present disclosure, a chat message sent by a peer end is received; an interaction option is provided according to message content of the chat message in response to determining to provide the interaction option based on the chat message, where the interaction option is associated with recommended reply content; and an operation of a user on the interaction option is received, and the recommended reply content associated with the interaction option is displayed. In this manner, the user is assisted in replying to the chat message, which helps improve information interaction efficiency and may improve user experience.

In a first aspect, according to one or more embodiments of the present disclosure, there is provided an information interaction method, including:
receiving a chat message sent by a peer end;
in response to determining to provide an interaction option based on the chat message, providing the interaction option according to message content of the chat message, where the interaction option is associated with recommended reply content; and
receiving an operation of a user on the interaction option, and displaying the recommended reply content associated with the interaction option.

According to one or more embodiments of the present disclosure, the method further includes:
obtaining a probability of providing the interaction option according to the message content of the chat message; and
in response to the probability being greater than a preset threshold, determining to provide the interaction option based on the chat message.

According to one or more embodiments of the present disclosure,
obtaining the probability of providing the interaction option according to the message content of the chat message includes:
inputting the chat message to a probability prediction model, and outputting, by the probability prediction model, the probability of providing the interaction option according to the message content of the chat message.

According to one or more embodiments of the present disclosure,
in response to determining to provide the interaction option based on the chat message, providing the interaction option according to the message content of the chat message includes:
in response to determining to provide the interaction option based on the chat message, inputting the chat message into a content generation model, and generating, by the content generation model, the recommended reply content according to the message content of the chat message; and
receiving the recommended reply content output by the content generation model, and generating the interaction option including the recommended reply content.

According to one or more embodiments of the present disclosure, before inputting the chat message into the content generation model, the method further includes:
splitting the chat message to obtain one or more sub-chat messages; and inputting the chat message into the content generation model, and generating, by the content generation model, the recommended reply content according to the message content of the chat message includes:
inputting each sub-chat messages to the content generation model, and generating, by the content generation model, the recommended reply content according to each sub-chat message respectively.

According to one or more embodiments of the present disclosure, splitting the chat message to obtain the one or more sub-chat messages includes:
generating prompt information including the chat message and splitting logic, where the splitting logic is used to split the chat message into the one or more sub-chat messages; and
inputting the prompt information into a language processing model, and splitting, by the language processing model, the chat message into the one or more sub-chat messages according to the splitting logic.

According to one or more embodiments of the present disclosure, the method further includes:
sending the recommended reply content to the peer end.

In a second aspect, according to one or more embodiments of the present disclosure, there is provided an information interaction device, including:
a receiving unit, configured to receive a chat message sent by a peer end;
a generation unit, configured to in response to determining to provide an interaction option based on the chat message, provide the interaction option according to message content of the chat message, wherein the interaction option is associated with recommended reply content; and
a displaying unit, configured to receive an operation of a user on the interaction option, and display the recommended reply content associated with the interaction option.

According to one or more embodiments of the present disclosure, the device further includes a determining unit, where the determining unit is configured to:
obtain a probability of providing the interaction option according to the message content of the chat message; and
in response to the probability being greater than a preset threshold, determine to provide the interaction option based on the chat message.

In an embodiment of the present disclosure, the determining unit is further configured to:
input the chat message to a probability prediction model, and output, by the probability prediction model, the probability of providing the interaction option according to the message content of the chat message.

In an embodiment of the present disclosure, the generation unit is further configured to:
in response to determining to provide the interaction option based on the chat message, input the chat message into a content generation model, and generate, by the content generation model, the recommended reply content according to the message content of the chat message; and
receive the recommended reply content output by the content generation model, and generate the interaction option including the recommended reply content.

In an embodiment of the present disclosure, the device further includes a splitting unit, where the splitting unit is configured to:
split the chat message to obtain one or more sub-chat messages; and
the generation unit is further configured to:
input each sub-chat message to the content generation model, and generate, by the content generation model, the recommended reply content according to each sub-chat message respectively.

In an embodiment of the present disclosure, the splitting unit is further configured to:
generate prompt information including the chat message and splitting logic, where the splitting logic is used to split the chat message into the one or more sub-chat messages; and
input the prompt information into a language processing model, and split, by the language processing model, the chat message into the one or more sub-chat messages according to the splitting logic.

In an embodiment of the present disclosure, the device further includes a sending unit, where the sending unit is configured to:
send the recommended reply content to the peer end.

In a third aspect, according to one or more embodiments of the present disclosure, there is provided an electronic device, including: at least one processor and a memory;
where the memory stores computer-executed instructions; and
the at least one processor executes the computer-executed instructions stored in the memory, to cause the at least one processor to execute the information interaction method according to the first aspect and various possible designs of the first aspect above.

In a fourth aspect, according to one or more embodiments of the present disclosure, there is provided a computer-readable storage medium, where computer-executed instructions are stored in the computer-readable storage medium, and when the computer-executed instruction is executed by a processor, the speech information processing method according to the first aspect and various possible designs of the first aspect above is implemented.

In a fifth aspect, according to one or more embodiments of the present disclosure, there is provided a computer program product, including a computer program, where when the computer program is executed by a processor, the speech information processing method according to the first aspect and various possible designs of the first aspect above is implemented.

In summary, it may be seen that a chat message sent by a peer end is received; an interaction option is provided according to message content of the chat message in response to determining to provide the interaction option based on the chat message, where the interaction option is associated with recommended reply content; and an operation of a user on the interaction option is received, and the recommended reply content associated with the interaction option is displayed. In this manner, a user is assisted in replying to the chat message, which helps improve information interaction efficiency and may improve user experience.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, and should also cover other technical solutions formed by the arbitrary combination of the above technical features or their equivalent features without departing from the above disclosure concept. For example, a technical solution formed by replacing the above features with technical features with similar functions disclosed in the present disclosure (but not limited thereto).

In addition, although the various operations are depicted in a particular order, this should not be understood as requiring the operations to be performed in the particular order shown or in a sequential order. Under certain circumstances, multitasking and parallel processing may be beneficial. Similarly, although the above discussion contains a number of specific implementation details, these should not be interpreted as limiting the scope of the present disclosure. Certain features described in the context of separate embodiments may also be implemented in a single embodiment in combination. On the contrary, various features described in the context of a single embodiment may also be implemented in multiple embodiments individually or in any suitable sub-combination.

Although the subject matter has been described in a language specific to structural features and/or method logic actions, it should be understood that the subject matter defined in the appended claims is not necessarily limited to the specific features or actions described above. On the contrary, the specific features and actions described above are only exemplary forms for implementing the claims.

1. An information interaction method, comprising:
receiving a chat message sent by a peer end;
in response to determining to provide an interaction option based on the chat message, providing the interaction option according to message content of the chat message, wherein the interaction option is associated with recommended reply content; and
receiving an operation of a user on the interaction option, and displaying the recommended reply content associated with the interaction option.

2. The method of claim 1, further comprising:
obtaining a probability of providing the interaction option according to the message content of the chat message; and
in response to the probability being greater than a preset threshold, determining to provide the interaction option based on the chat message.

3. The method of claim 2, wherein obtaining the probability of providing the interaction option according to the message content of the chat message comprises:
inputting the chat message to a probability prediction model, and outputting, by the probability prediction model, the probability of providing the interaction option according to the message content of the chat message.

4. The method of claim 1, wherein in response to determining to provide the interaction option based on the chat message, providing the interaction option according to the message content of the chat message comprises:
in response to determining to provide the interaction option based on the chat message, inputting the chat message into a content generation model, and generating, by the content generation model, the recommended reply content according to the message content of the chat message; and
receiving the recommended reply content output by the content generation model, and generating the interaction option comprising the recommended reply content.

5. The method of claim 4, wherein before inputting the chat message into the content generation model, the method further comprises:
splitting the chat message to obtain one or more sub-chat messages;
wherein inputting the chat message into the content generation model, and generating, by the content generation model, the recommended reply content according to the message content of the chat message comprises:
inputting each sub-chat message to the content generation model, and generating, by the content generation model, the recommended reply content according to each sub-chat message respectively.

6. The method of claim 5, wherein splitting the chat message to obtain the one or more sub-chat messages comprises:
generating prompt information comprising the chat message and splitting logic, wherein the splitting logic is used to split the chat message into the one or more sub-chat messages; and
inputting the prompt information into a language processing model, and splitting, by the language processing model, the chat message into the one or more sub-chat messages according to the splitting logic.

7. The method of claim 1, further comprising:
sending the recommended reply content to the peer end.

8. An electronic device, comprising: at least one processor and at least one memory,
wherein the at least one memory stores computer-executed instructions; and
the at least one processor executes the computer-executed instructions stored in the at least one memory, to cause the at least one processor to execute an information interaction method, wherein the method comprises:
receiving a chat message sent by a peer end;
in response to determining to provide an interaction option based on the chat message, providing the interaction option according to message content of the chat message, wherein the interaction option is associated with recommended reply content; and
receiving an operation of a user on the interaction option, and displaying the recommended reply content associated with the interaction option.

9. The electronic device of claim 8, wherein the method further comprises:
obtaining a probability of providing the interaction option according to the message content of the chat message; and
in response to the probability being greater than a preset threshold, determining to provide the interaction option based on the chat message.

10. The electronic device of claim 9, wherein obtaining the probability of providing the interaction option according to the message content of the chat message comprises:
inputting the chat message to a probability prediction model, and outputting, by the probability prediction model, the probability of providing the interaction option according to the message content of the chat message.

11. The electronic device of claim 8, wherein in response to determining to provide the interaction option based on the chat message, providing the interaction option according to the message content of the chat message comprises:
in response to determining to provide the interaction option based on the chat message, inputting the chat message into a content generation model, and generating, by the content generation model, the recommended reply content according to the message content of the chat message; and
receiving the recommended reply content output by the content generation model, and generating the interaction option comprising the recommended reply content.

12. The electronic device of claim 11, wherein before inputting the chat message into the content generation model, the method further comprises:
splitting the chat message to obtain one or more sub-chat messages;
wherein inputting the chat message into the content generation model, and generating, by the content generation model, the recommended reply content according to the message content of the chat message comprises:
inputting each sub-chat message to the content generation model, and generating, by the content generation model, the recommended reply content according to each sub-chat message respectively.

13. The electronic device of claim 12, wherein splitting the chat message to obtain the one or more sub-chat messages comprises:
generating prompt information comprising the chat message and splitting logic, wherein the splitting logic is used to split the chat message into the one or more sub-chat messages; and
inputting the prompt information into a language processing model, and splitting, by the language processing model, the chat message into the one or more sub-chat messages according to the splitting logic.

14. The electronic device of claim 8, wherein the method further comprises:
sending the recommended reply content to the peer end.

15. A non-transitory computer-readable storage medium, wherein computer-executed instructions are stored in the non-transitory computer-readable storage medium, and when the computer-executed instructions are executed by a processor, an information interaction method is implemented, wherein the method comprises:
receiving a chat message sent by a peer end;
in response to determining to provide an interaction option based on the chat message, providing the interaction option according to message content of the chat message, wherein the interaction option is associated with recommended reply content; and
receiving an operation of a user on the interaction option, and displaying the recommended reply content associated with the interaction option.

16. The non-transitory computer-readable storage medium of claim 15, wherein the method further comprises:
obtaining a probability of providing the interaction option according to the message content of the chat message; and
in response to the probability being greater than a preset threshold, determining to provide the interaction option based on the chat message.

17. The non-transitory computer-readable storage medium of claim 16, wherein obtaining the probability of providing the interaction option according to the message content of the chat message comprises:
inputting the chat message to a probability prediction model, and outputting, by the probability prediction model, the probability of providing the interaction option according to the message content of the chat message.

18. The non-transitory computer-readable storage medium of claim 15, wherein in response to determining to provide the interaction option based on the chat message, providing the interaction option according to the message content of the chat message comprises:
in response to determining to provide the interaction option based on the chat message, inputting the chat message into a content generation model, and generating, by the content generation model, the recommended reply content according to the message content of the chat message; and
receiving the recommended reply content output by the content generation model, and generating the interaction option comprising the recommended reply content.

19. The non-transitory computer-readable storage medium of claim 18, wherein before inputting the chat message into the content generation model, the method further comprises:
splitting the chat message to obtain one or more sub-chat messages;
wherein inputting the chat message into the content generation model, and generating, by the content generation model, the recommended reply content according to the message content of the chat message comprises:
inputting each sub-chat message to the content generation model, and generating, by the content generation model, the recommended reply content according to each sub-chat message respectively.

20. The non-transitory computer-readable storage medium of claim 19, wherein splitting the chat message to obtain the one or more sub-chat messages comprises:
generating prompt information comprising the chat message and splitting logic, wherein the splitting logic is used to split the chat message into the one or more sub-chat messages; and
inputting the prompt information into a language processing model, and splitting, by the language processing model, the chat message into the one or more sub-chat messages according to the splitting logic.
